(19) United States
(12) Patent Application Publication
(10) Pub. No.: US 2003/0145431 A1
(43) Pub. Date: Aug. 7, 2003

(54) Handle mounted on packaging and tool used to mount said handle

(76) Inventor: Alain Dufrene, Mormoiron (FR)

Correspondence Address: GREENBLUM & BERNSTEIN, P.L.C., 1950 ROLAND CLARKE PLACE, RESTON, VA, 20191, US

(21) Appl. No.: 10/257,986

(22) PCT Filed: Jan. 30, 2002
(86) PCT No.: PCT/FR02/00352

(30) Foreign Application Priority Data
Jan. 31, 2001 (FR) 01/01282

(51) Int. Cl. E05B 1/00

(52) U.S. Cl. 16/422

(57) ABSTRACT

The invention relates to a handle mounted on packaging and the tool used to mount said handle. Said invention comprises (i) continuous strips of flat handles (1) produced in such a way as to leave bridges (12) between said handles so as to be easily cut while being mounted on a package and (ii) adjustable guide rails (59) disposed so as to allow the ends of the handles (1) to be brought closer together and oriented such that the ends are positioned exactly at the base of the slits disposed on the package and intended to house said ends, while bending the body of the handle. The invention relates to the industrial and commercial production and distribution of packaging accessories.

The present invention relates to a handle mounted on a package, as well as the tool adapted for its mounting.

It relates to the industrial and commercial manufacture and distribution of accessories for packages.

It is common to equip packages made of cardboard or the like with molded or injected plastic handles.

These handles generally have a body or central portion shaped like a strap, provided at each end with a gripping tab that confers to each end of this handle a “T” or “V” shaped profile, and adapted to be engaged, from the outside, into a slit provided for this purpose in the wall of the package, each tab being folded or tilted against the body of the handle prior to its engagement in the slit for which it is adapted.

In order to allow the user to grip the handle and to slip his hand between the handle and the wall of the package, the distance separating the slits provided in the wall of the package for passing and securing the gripping tabs is less than the length of the body of the handle that, as a result, must be partially bent before engaging the tabs in the slits. It is noted that this maneuver is difficult to achieve automatically.

There have been attempts at automating the positioning of individually manufactured handles, whose cost of production is very low, but the machines designed for this end are complex, expensive, slow and not very reliable.

The Patent No. FR 2 619 551 filed by the Applicant of the present invention describes a handle of the aforementioned type adapted to be automatically mounted, the body of the handle being bent during manufacture such that its ends are separated one from the other by a distance equal to the distance separating the slits provided in the wall of the package for which it is adapted. The gripping tabs are flat, and the handle is obtained in a way that each of these tabs forms a sharp angle with the corresponding end of the body, so as to be parallel to the gripping tab located at the other end.

In order to facilitate the automatic mounting of the handles, the latter are manufactured in strips, each of which are constituted of a plurality of handles assembled side by side by bridges made of easily cut material. This arrangement has the advantage of substantially facilitating the feeding of the mounting machines.

Nevertheless, these handles have a certain number of drawbacks:

the shaping mold is expensive and allows for only slow production rates, thereby generating a high production cost with respect to individual handles,

the shape of the handle limits the winding possibilities and the number of handles per roll is often found to be insufficient (separate machines),

the mid-point of the positioning holes on the package is related to the shape of the handle, which imposes minimum dimensions for the package that is to receive the handle,

the pushing devices or positioning fingers are limited to simply pushing the handle, without ensuring at all that it holds, which can lead to some positioning issues.

The object of the device according to the present invention is to overcome these drawbacks. Indeed, it allows one to obtain handles with the usual shape that approximate economical handles, the mounting of which can be automatically ensured by a simple and reliable positioning machine.

It is constituted by associating continuous strips of flat handles achieved in such a way as to leave, between each of them and the handles adjacent to them, bridges that are easily cut when mounted on a package, and adjustable guide rails arranged to ensure both the bringing together and the orientation of the ends of the handle, such that said ends are positioned directly perpendicular to the slits of the package adapted to receive them, while causing the body of the handle to bend.

In the attached drawings that are given by way of non-restrictive examples of embodiments of the object of the invention:

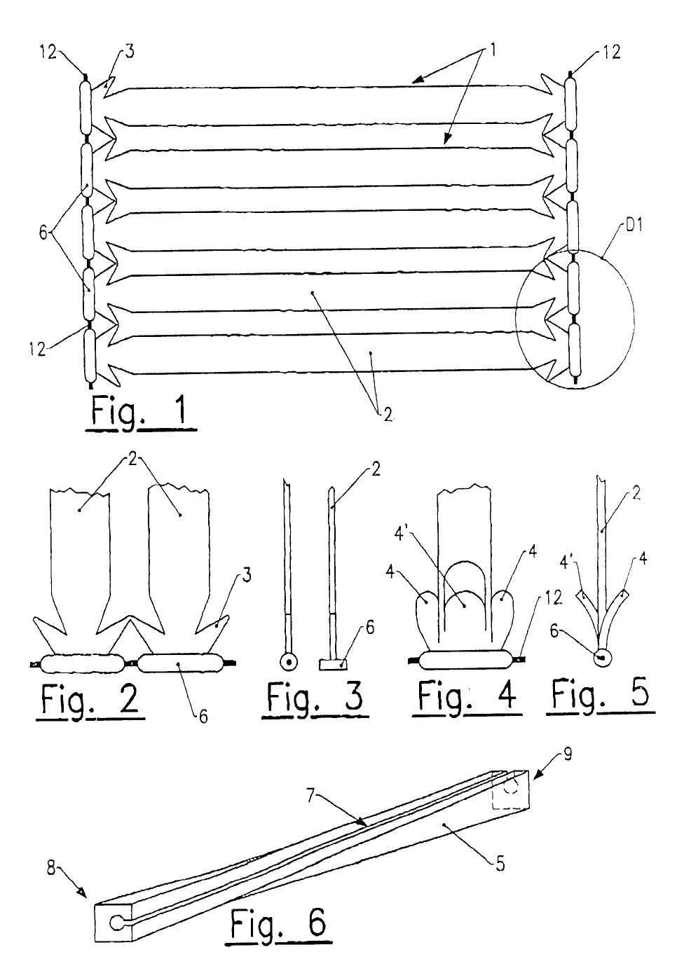

FIG. 1 shows a portion of a strip made of flat handles,

FIG. 2 is a front view of an enlargement of the detail D1 of FIG. 1,

FIG. 3 shows side views of two alternative embodiments of the end of the handle,

FIGS. 4 and 5 show a different type of end of the handle, under the same conditions as FIGS. 2 and 3,

FIG. 6 is an axonometric view of a guide rail,

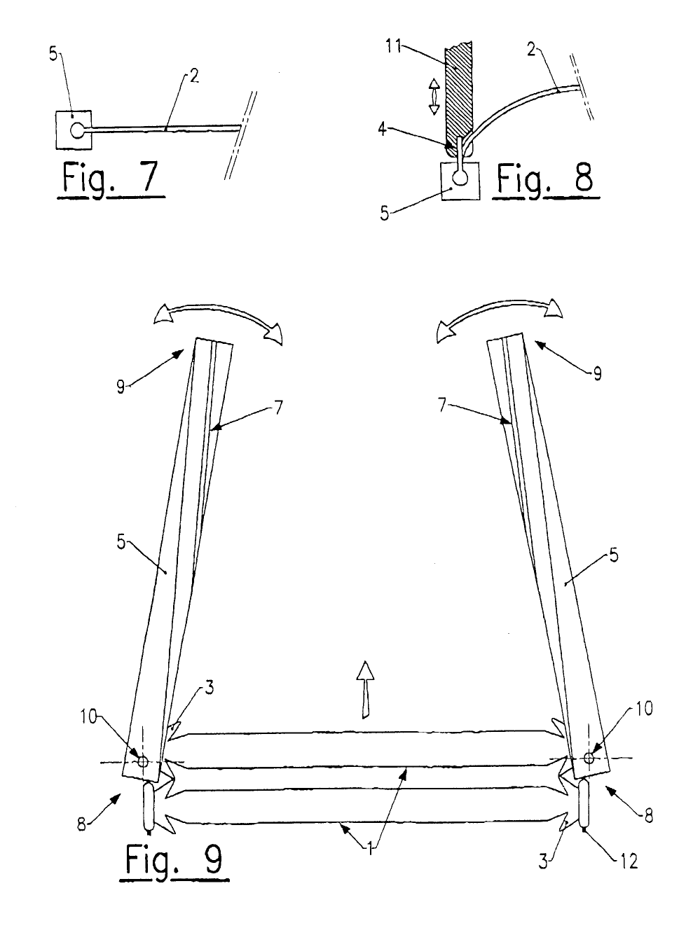

FIG. 7 shows an end view of the entry end of a guide rail with a partial representation of a handle before it is bent,

FIG. 8 shows, under the same conditions, the exit end of the guide rail as well as the pushing device for positioning the handles,

and FIG. 9 shows a top view of two guide rails with a handle strip in place.

The device, FIGS. 1-9, is constituted of handles 1 comprising a central body 2 shaped like a semi-rigid strap equipped with anchoring elements 3, 4, 4′ at each of its ends, and of two guide rails 5 adapted to be mounted on the automatic mounting machine to bring the handles above the slits provided in the package in order to allow their attachment.

Before they are mounted, the handles are flat and are presented in the shape of a continuous strip manufactured by molding or extruding plastic, such as polyethylene, polyvinyl chloride or the like.

The anchoring elements can be of two types:

lugs 3 arranged laterally in the plane of the handle (FIGS. 2 and 3),

tabs 4, 4′ that are tilted with respect to the plane of the handle (FIGS. 4 and 5).

The lugs 3 and the tabs 4 are configured so as to be folded back along the central body 2 when they penetrate into the slit of the package and to be spread apart through elasticity in order to maintain the handle in place.

Bulges 6 are provided at the ends of each handle which are adapted to slide in the guide rails 5.

The guide rails 5 are provided with a longitudinal groove 7 in which the bulges 6 of the handles 1 are engaged. The mid-point between the axes of the rails varies and decreases when going from the entry point 8 to the exit point 9 of the rails, so as to bring the ends of the handle closer together in order for them to be directly perpendicular to the slits of the package, while forcing the handle to bend.

The mid-point between the axes of the exit of the guide rails can be advantageously made adjustable by journaling them about an axis 10 located in the proximity of the entry point 8, which enables the same handles to be used for different packages.

The grooves 7 comprise a necking adapted to prevent the exit of the bulge 6 from escaping during its passage along the length of the rail, and they are helical in shape so as to force the ends of the handles to make a quarter of a turn so that they are in a plane perpendicular to the wall of the package when exiting the guide rail 5.

Each handle 1 that extends past the farther end of the guide rail 5 is then displaced in the direction of the wall of the package, toward the slits of the latter, by two pushing devices 11 having an alternative vertical displacement, the head of which conforms to the shape of the handle in order to ensure its position during the entire positioning phase, these pushing devices causing the anchoring elements 3, 4, 4′ to be engaged in said slits until they are completely engaged beyond the wall of the package.

The two pushing devices 11 are advantageously activated by a single vertical jack ensuring both the horizontal advance of the handles by means of levers and a driving system of a known type.

The positioning of the handles 2 on the packages adapted to receive them is substantially improved because the handles 1 are packaged in strips, each of which comprises a plurality of handles connected one to the other by material bridges 12. In this manner, each handle is easily guided by the guide rails 5 of the mounting machine. The means for the positioning of the handles 1 include, in addition to the guide rails 5 and the pushing devices 11, blades located just past the end of the guide rails so that each of the blades acts as a shearing blade for the material bridges 12.

The positioning of the various component elements gives the object of the invention a maximum of useful effects that until now had not been obtained by similar devices.

1. Device constituted of a handle attached to a package and of a tool adapted for its mounting, having the object of positioning handles by an automatic machine on packages made of cardboard or the like,
characterized by the combination, on the one hand, of flat handles (1) packaged in continuous strips and obtained so as to leave, between each of them and those adjacent to them, bridges (12) that are easily cut when mounted on a package, and, on the other hand, guide rails (5) provided to ensure both the bringing together and the orientation of the ends of the handles (1) such that said ends are directly perpendicular to the slits provided in the package and adapted to receive them, while causing the body of the handle to bend.

2. Device according to claim 1, characterized in that at each of their ends the handles comprise bulges (6) adapted to slide in the guide rails (5).

3. Device according to claim 2, characterized in that the guide rails (5) are provided with a longitudinal groove (7) in which the bulges 6 of the handles (1) are engaged, said groove comprising a necking adapted to prevent the bulge (6) of the handle (1) from escaping during its passage along the length of said guide rail.

4. Device according to any of the preceding claims, characterized in that the midpoint between axes of the guide rails (5) varies and decreases when passing from the entry point (8) to the exit point (9) of said rails, so as to bring the ends of the handle closer together in order for them to be directly perpendicular to the slits of the package.

5. Device according to claim 4, characterized in that the mid-point between the axes of the exit of the guide rails (5) is made adjustable by journaling said rails about an axis (10) arranged in the proximity of the entry point (8), so as to use the same handles (1) for different packages.

6. Device according to any of claims 3-5, characterized in that the grooves (7) of the guide rails are helical in shape so as to force the ends of the handles (1) to make a quarter turn in order to be in a plane perpendicular to the wall of the package when exiting the guide rails (5).

7. Device according to any of the preceding claims, characterized in that at the farther end of each guide rail (5) is arranged a pushing device (11) having an alternative vertical displacement, the head of which conforms to the shape of the handle (1) in order to ensure its position during the entire positioning phase, said pushing devices causing the anchoring elements (3, 4, 4′) to be engaged in the slits of the package adapted to receive them until they are completely engaged beyond the wall of said package.

8. Device according to claim 7, characterized in that the two pushing devices (11) are activated by a single vertical jack that ensures both the horizontal advance of the handles by means of levers and a driving system of a known type.

9. Device according to any of claims 4-8, characterized in that shearing blades are arranged just past the end of the guide rails (5) to cut the material bridges (12) connecting the handles (1) one to the other.

10. Device according to any of the preceding claims, characterized in that at their ends the handles (1) comprise anchoring elements (3, 4, 4′) configured so as to fold back against the central body (2) of the handle when they penetrate into the slit of the package and to spread apart through elasticity in order to maintain said handle in place.

11. Device according to claim 10, characterized in that the anchoring elements are constituted of lugs (3) arranged laterally in the plane of the handle (1).

12. Device according to claim 10, characterized in that the anchoring elements are constituted of tabs (4, 4′) that are tilted with respect to the plane of the handle (1).
